(19) United States
(12) Patent Application Publication
(10) Pub. No.: US 2004/0078332 A1
(43) Pub. Date: Apr. 22, 2004

(54) System and method for purchasing goods and services through data network access points over a point of sale network

(76) Inventors: Ronald Gene Ferguson, Overland Park, KS (US); Jeffrey Scott Clary, Overland Park, KS (US); Mark Andrew Witherell, Maumelle, AR (US); Thierry Marc Michel, Neuilly/Seine (FR)

Correspondence Address: PIP Consulting, 4326 Sothern Avenue, S.E., Washington, DC, 20019, US

(21) Appl. No.: 10/387,441

(22) Filed: Mar. 14, 2003

Related U.S. Application Data
(60) Provisional application No. 60/363,884, filed on Mar. 14, 2002.

(51) Int. Cl. G06F 17/60

(52) U.S. Cl. 705/41

(57) ABSTRACT

A system and method for purchasing pre-paid account cards and replenishing pre-paid accounts for goods and services. The system includes a data source containing data descriptive of a prepaid account. The data source is accessible by a transaction system for responding to user service transactions and may be accessible by a fulfillment service provider for providing the goods or services based upon the prepaid account data. The system is accessed through a variety of service end points comprising point of sale (POS) systems.

### CROSS-REFERENCE TO RELATED APPLICATIONS

The present application claims priority to U.S. Provisional Application No. 60/363,884, entitled “SYSTEM AND METHOD FOR PURCHASING GOODS AND SERVICES THROUGH FINANCIAL DATA NETWORK ACCESS POINTS OVER A POINT OF SALE NETWORK,” filed Mar. 14, 2002. This prior application is incorporated herein by reference.

### BACKGROUND OF THE INVENTION

1. Field of the Invention

This invention relates to the field of the electronic purchase of goods and services using mobile components, including prepaid account cards, via data network access points utilizing a point of sale network.

2. Description of the Related Art

Many goods and services are conveniently purchased by means of a prepaid account card. Prepaid accounts offer a number of conveniences to both customers and the providers of the good/services.

Communication services, including mobile phone service, public phone service, residential phone service, Internet service, long distance service, and other services, are delivered through a large number of public communication systems. Many of these systems require pre-payment in order to utilize the system's services. For example, public phones may require currency, a phone card number, or the access code from a pre-paid phone card. Similarly, many mobile phone customers choose to prepay for their phone time. This is particularly prevalent in Europe. Access to public electronic mail, video phones, and Internet terminals may also require prepayment. For many of these systems it is difficult or inconvenient to construct the hardware and transaction protocols for accepting electronic payment. For example, magnetic card readers and secure connections to an electronic funds transfer network, or other data network, may impose undesirable technical requirements for some public and mobile communication systems.

Presently, many users of such public and mobile communication systems purchase cards in varying currency denominations (for example, $30 of long distance) or quantities of communication time (for example, 30 minutes of mobile air time). These cards provide an access number which is presented to the communications system (e.g., by dialing the access number prior to dialing the destination telephone number) to access the prepaid quantity of communication services. The access number is linked through the communication system to a prepaid account database which tracks the amount of time or money remaining in the prepaid account. Presently, such prepaid phone cards are sold primarily through retail convenience locations, such as drug stores, gas stations, and grocery stores, and, in some locations, vending machines. This method of distribution entails extra costs for the production, distribution, and retail mark up of the cards. Further, only set denominations of cards are available; not all retailers are available 24 hours a day, seven days a week; and, few vending machines accept credit or debit card payments.

There come times when a customer having a prepaid account card desires to add additional funds to the prepaid account. Such transactions can be referred to as “replenishment transactions.”

It is possible to replenish a prepaid account through an automated teller machine (ATM) network using a credit/debit card. However, such an approach would require the customer seeking to replenish his/her prepaid account using a credit/debit card to proceed through a number of inconvenient menus to achieve the replenishment transaction.

Accordingly, there remains a need for providing a convenient system and method for adding additional funds to prepaid accounts by means of data network access points over a point of sale (POS) network utilizing a credit or debit card or cash. This has not been available in the prior art.

### BRIEF SUMMARY OF THE INVENTION

It is therefore an object of the invention to overcome the above-mentioned drawbacks of prior systems.

It is an additional object of the invention to provide a system and method for purchasing goods and services through secure data networks using POS access points.

Additional objects and advantages of the invention will be set forth in part in the description which follows and in part will be obvious from the description, or may be learned by practice of the invention.

These and other objects of the preferred embodiments are particularly achieved by a system and method for providing a prepaid account card linked to a prepaid account number through a POS terminal device connected to a data network. The user, by swiping a prepaid account card, accesses the POS terminal, either directly or through a merchant operating the POS terminal, and, using cash, check, credit or debit, replenishes an amount in the prepaid account. The POS terminal adds credit to the prepaid account through the data network and returns an approval response from a database accessible by the goods/services provider. The approval response then indicates that the prepaid account can now be utilized for goods or services, such as access to a predetermined quantity of communication services.

The accompanying drawings, which are incorporated in and constitute a part of this specification, illustrate an embodiment of the invention and, together with the description, serve to explain the principles of the invention.

### BRIEF DESCRIPTION OF THE DRAWINGS

Features and advantages of the present invention will become apparent from the following description of an embodiment thereof, by way of example only, with reference to the accompanying drawings, in which:

FIG. 1 is a schematic view of a system for purchasing goods and services through a POS network according to one embodiment of the invention.

FIG. 2a is a schematic view of a system for purchasing goods and services through a data network using one or more of a variety of terminal devices according to an embodiment of the invention.

FIG. 2b is a schematic view of a modular application system for use in an embodiment of the invention, such as the system of FIG. 2a.

FIG. 3 is a schematic view of a transaction system for purchasing goods and services through a data network using one or more of a variety of service end points according to an embodiment of the invention.

FIG. 4 is a flow chart illustrating steps in a method of using a transaction system for prepaid account card-based purchase of goods and services through a data network according to an embodiment of the invention.

FIG. 5 is a flow chart illustrating steps in a method of replenishing a prepaid account redeemable for goods and services through a transaction system connected to a data network according to an embodiment of the invention.

FIG. 6 is a flow chart illustrating steps in a method of providing goods and services through a prepaid account replenished through a transaction system connected to a data network according to an embodiment of the invention.

### DETAILED DESCRIPTION OF THE INVENTION

Reference will now be made in detail to the present preferred embodiment of the invention, an example of which is illustrated in the accompanying drawings in which like reference characters refer to corresponding elements.

In one preferred embodiment, the present invention is implemented through an arrangement between merchants (e.g., convenience stores), a replenishment processor (for processing replenishment transactions), a POS processor (for processing POS transactions), and wireless carriers (or their agents for performing wireless billing transactions).

For example, the merchant could be a participating gas station. The replenishment processor may be a computer system operated by Euronet Worldwide, Inc. and interfacing between a wireless carrier and a POS processor. The POS processor could be any acceptable POS processor on a POS network. By way of example, various POS processors (e.g., that operated by Concord) on the STAR POS network could be employed. The wireless carrier could be any wireless carrier, such as Verizon, AT&T, among others. Alternatively, the wireless carrier function can be performed by a third party billing agent. Often billing functions for many wireless carriers in the United States are carried out by third party billing agents; for example, the Boston Communications Group performs billing operations for a number of wireless carriers in the United States.

It will further appreciated that the POS terminal of the present invention can include devices in which the POS terminal is incorporated into a merchant's cash register. Additional embodiments of the present invention include those in which other devices, such as telephones, mobile phones, and DirectTV devices, among others, can function as the POS devices.

According to one aspect of the present invention, the replenishment transaction is supported by the existing POS infrastructure (e.g., the POS terminals, the POS network, and the POS processor) with little or no changes. In this embodiment of the present invention electronic replenishment transactions can be implemented with minimal change to the existing POS infrastructure.

According to one preferred aspect of the present invention, the present invention comprises a system and method that uses a prepaid account card that electronically identifies the user's prepaid account to the POS terminal, obviating the need to enter prepaid account details at the POS terminal.

For example, such a prepaid account card could comprise a swipe card, such as a Universal Phone Card (UPC) having a magnetic stripe with a preset account number. The card can also include bank identification number (BIN) information that designates the replenishment processor as the issuing party. In addition, the card can also provide a wireless carrier. Such replenishment cards may be distributed in a variety of methods. The cards may be included with cellular phones distributed by wireless carriers to subscribers. They may also be sold in retail outlets by merchants, such as gas stations, supermarkets and convenience stores.

It will be appreciated that the present invention is not limited to UPC cards; a wide variety of prepaid account cards can be utilized in the present invention. Indeed, smart cards can be employed in the present invention. Rather than employing information encoded on a magnetic strip, smart cards include a microprocessor with a memory element embedded within some physical form. With a microprocessor, smart cards interact with terminals across a broader range of transactions and are able to communicate a broader and more detailed range of information regarding the cardholder, a cardholder account, transaction authorization, and other information.

Further, alternative embodiments of the present invention for providing a prepaid account number are encompassed within the present application. Specifically, any method for providing the prepaid account number to the POS terminal, such as a bar code linked to the prepaid account number provided on a mobile phone, a bar code linked to the prepaid account number displayed on the screen of a mobile phone, communication of the prepaid account number to the POS terminal by means of an infrared port on a mobile phone, communication of the prepaid account number by radio frequency methodology, including Bluetooth technology, among others, are included within the scope of the present invention.

The prepaid account card containing the user's prepaid account number component of the present invention offers several advantages. Often a user may have forgotten their phone number/prepaid account number or they may be replenishing someone else's prepaid account. In addition, users may consider it a personal security risk to provide their phone number/prepaid account number. Further, the transaction is considerably slower if the phone number/prepaid account number needs to be entered, especially if the phone number is entered twice to try to avoid keying errors. Phone number/prepaid account number entry also carries the risk that the number is miskeyed or misunderstood by the merchant.

Preferably the prepaid account card has no pre-established value associated with it and it is not usable until activated or registered. The prepaid account card may be wireless carrier-specific or may include data (e.g., stored in the magnetic stripe separate from or part of the prepaid account number field) that indicates the wireless carrier. In this latter embodiment, another processor (e.g., the replenishment processor or a third party billing agent) is capable of identifying the wireless carrier corresponding to a particular prepaid account number/mobile phone number.

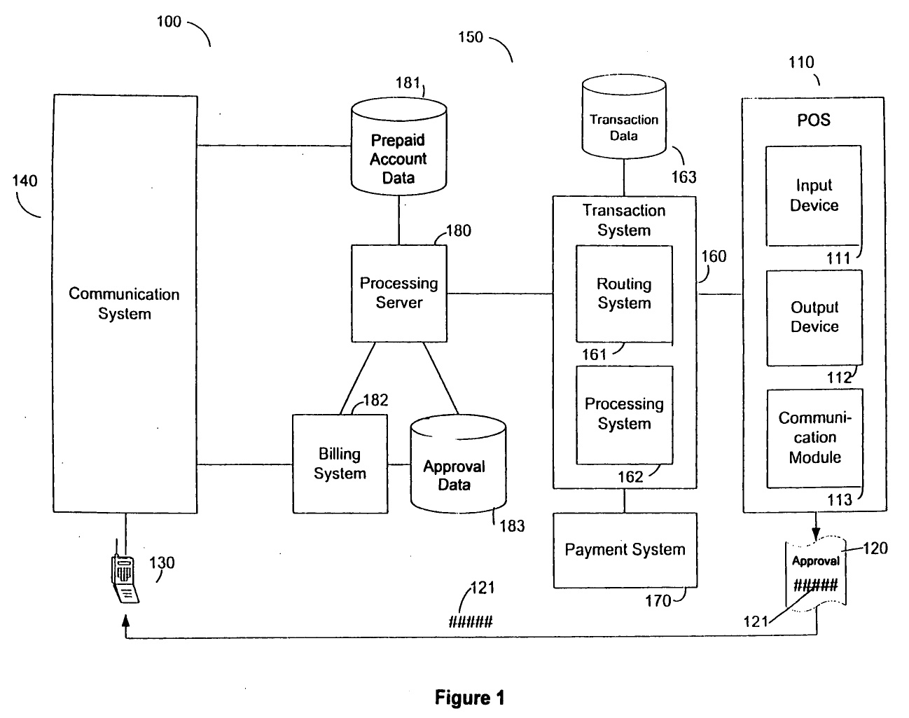

With reference to the drawing figures generally, and particularly to FIG. 1, a system 100 for purchasing goods and services through a POS terminal 110 according to one embodiment of the invention is shown. System 100 allows a user to access POS Terminal 110 with a prepaid account card for a transaction using cash, credit card, bank card, debit card, electronic wallet, or stored value card, among others, and to select an amount to be prepaid towards a product or service for purchase, such as prepaid communication services. Pre-payment for the product or service is handled like a balance transfer or account withdrawal through a Data Network 150 to which POS Terminal 110 is connected. POS Terminal 110 retrieves or generates an appropriate Approval Response 120 for the product or service. POS Terminal 110 prints or displays Approval Response 120 for the user.

It will be appreciated that the data network component of the present invention can be a financial data network, a replenishment processor data network, a private data network, a POS data network, and a public data network, among others.

POS Terminal 110 provides a publicly accessible terminal device for accessing one or more functions that are at least in part provided through Data Network 150. It will be appreciated that, in one preferred embodiment, the POS terminal accesses the data network through a POS network. POS Terminal 110 may be one of a variety of terminal devices for providing consumer access to prepay for a variety of products and services provided through Data Network 150. In one embodiment, POS Terminal 110 includes an Input Device 111, an Output Device 112, and a Communication Module 113. Input Device 111 provides the user with the mechanism for using the prepaid account card and to enter other information into POS terminal 110. For example, Input Device 111 may include a magnetic card reader, a chip reader, a number pad, a biometric sensor (e.g., thumbprint or retinal scanner), or other input devices, such as a keyboard, a digital camera, etc. Output Device 112 provides the user/merchant with a way of receiving information from POS terminal 110. For example, Output Device 112 may include a display screen, one or more speakers, a printer, or other output devices. Communication Module 113 provides a way for POS terminal 110 to communicate, directly or indirectly, with Data Network 150 and any other external transaction systems, networks, servers, data sources, or other systems enabling POS Terminal 110's functions. POS Terminal 110 may include one or more resident data processors, memory systems, and/or logic systems (e.g., software) for enabling local storage and processing of information for some functions. In one embodiment, POS Terminal 110 includes thin client software and utilizes the data processing, memory, and software applications of one or more remote servers for its functions. In an alternate embodiment, POS Terminal 110 may include the majority of the data processing, storage, and functional logic for performing its functions and communicate with external systems only for limited data exchanges with external data sources and transaction systems. The use of a POS terminal as an access point and for prepaying for the purchase of goods and services allows a merchant to utilize an existing network of input/output terminals stationed in convenient locations and providing 24 hour, 7 day a week access for many consumers. Additionally, the added data processing and storage capabilities achieved by advances in computer technology and by the efficiencies offered in ubiquitous and higher bandwidth communication networks provided banks and other supporters of the existing POS networks with the ability to add more diverse functions to their POS terminals. These features and functions may be added without decreasing the POS terminal's functionality for the financial transactions for which they were designed and put in place. POS Terminal 110 may be just one of a variety of access points capable of accessing the transactional systems of data network 150, as described below.

In one embodiment, the data network is accessed by a merchant who has received a cash payment from the user. The merchant uses one of the POS terminals described above to input information concerning the transaction and confirm the purchase, for example, the mobile phone company in the case of purchase of prepaid time on a mobile phone network. The transaction is settled by a cash payment between the merchant and the consumer.

Settlement via credit card or debit card can be achieved through a number of mechanisms that well-known. Many data card transactions involve third-party credit card transaction processors in addition to the merchant and credit card issuer. Transaction processors, which are sometimes independent business institutions, provide merchants with data processing services that facilitate the flow of credit card transaction data and the corresponding payments of monies between the merchants and card issuers. The flow of transaction data from the merchant to the issuer via a transaction processor is commonly referred to as “processing” or “clearing” the transactions. The flow of money from the issuer to the merchant via a processor is known as “settlement” The term “transaction processor” generally means a third-party institution that processes card transactions independently of a card issuer, but can also include card issuers and card issuing associations that process their own transactions

Approval Response 120 is a credit with one or more product or service providers which represents payment received for a product or service yet to be rendered, in whole or in part. Approval Response 120 need not be tangible; it may be embodied solely in electronic information contained on the prepaid account card. For example, Approval Response 120 may be information displayed upon a display screen or may be an audible message conveyed through a speaker. In some embodiments, however, approval response 120 may be embodied in a physical form, such as printed on a POS terminal receipt. In one embodiment, Approval Response 120 may correspond to an entry in a database of service provider information for tracking such credits. Approval Response 120 is linked to a prepaid account number, such as Prepaid Account Number 121.

Communication Device 130 allows a user to utilize approval response 120 for the communication services, or other products or services, transacted for through POS terminal 110. Communication Device 130 is connected to Communication System 140 for providing communication services to the user of communication device 130. Communication Device 130 may include any type of communication device, such as a mobile phone, public telephone, two-way radio, video phone, electronic mail terminal, computer, Internet connection, or other communication device.

Communication System 140 may be any public or proprietary communication system and may or may not be interconnected to the worldwide communication network. Communication System 140 receives Prepaid Account Number 121 and/or a request for redemption of the prepaid account through Communication Device 130 and provides the requested communication services to the user. For example, Communication System 140 may allow a user to place a long distance phone call, send an electronic mail message, send an instant message to a particular terminal device, send a query to a data system, or similar functions. Approval Response 120 may provide access to a predetermined quantity of the communication services, such as a set period of time, a set number of messages, a period of unlimited use, and one or more rates debited against a prepaid account value, or any other quantity of usage rights, including combinations of those listed here. In order to provide access to communication services in accordance with Approval Response 120 and to keep track of use of Approval Response 120, where usage is limited, Communication System 140 validates Prepaid Account Number 121 and uses Prepaid Account Number 121 to access details of the prepaid account, such as Prepaid Account Data 181. In one embodiment, Prepaid Account Number 121 provides access to a user Approval Data 183 through a Billing System 182. Prepaid Account Data 181, Billing System 182, and Approval Data 183 may be maintained as part of Communication System 140 or Data Network 150. Alternatively, approval response Data 181, Billing System 182, and/or Approval Data 183 may be provided by a third party or as an independent system connected to Communication System 140 and Data Network 150.

Data Network 150 may include a variety of interconnected systems for providing financial services to consumers, service providers, and financial institutions. In one embodiment, Data Network 150 includes a Transaction System 160 including a Routing System 161 and a Processing System 162. Data Network 150 may include one or more payment systems, such as Payment System 170. Payment System 170 may include a clearinghouse for financial transactions, such as a bank providing electronic account access or a credit card company. Data Network 150 may include one or more data processing servers, such as Processing Server 180, for providing financial and service data and data processing in response to queries and service requests. Processing servers may communicate with one or more data repositories or data processing systems, such as approval response Data 181, Billing System 182, and Approval Data 183. Data Network 150 may include an isolated data network, such as an intranet, business-to-business network, or other proprietary network, or may use security and access limiting protocols within a general use wide area network, such as the Internet.

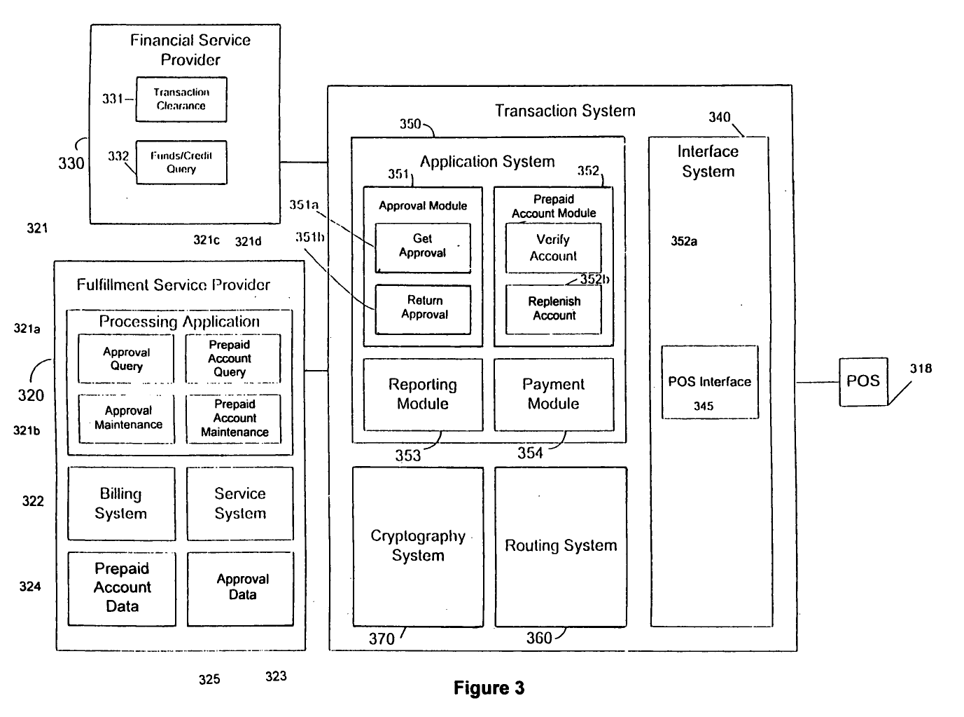

Transaction System 160 may include one or more systems for directing data between networked resources included within or connected to Data Network 150 and may also include functional logic for providing additional processing. Transaction System 160 may also include or be connected to a data source, such as Transaction Data 163, for recording and tracking transaction details for transactions passing through Transaction System 160. Routing System 161 may include switching technology for directing data flow and communications through a network. For example, Routing System 161 may provide switching services for a variety of financial institutions and financial service providers, allowing those institutions and service providers to communicate financial data among themselves securely. For example, a request for a prepaid account balance placed through POS Terminal 110 may be directed by Routing System 161 to the organization maintaining the prepaid account according to information encoded in the user's prepaid account card. As in the preceding example, Routing System 161 may receive communication data and distribute it according to addressing and/or communication protocols contained in the data (e.g., the information on the location of the user's prepaid account contained in the magnetically encoded information read by POS Terminal 110). Routing System 161 may receive requests for a communication channel and provide protocols for securing and timing communications through the communication channel. In one embodiment, Routing System 161 may communicate with one or more worldwide communication networks. Routing System 161 may rout data using to International Electronic Funds Transfer security and communication protocols. Routing System 161 may rout data using Internet protocols. Processing System 162 may provide the logic for providing consumer services through Transaction System 160. Processing System 162 may include a system for evaluating service requests and directing service requests to an appropriate service provider. In one embodiment, Processing System 162 may evaluate a service request and provide at least a portion of the data processing required for fulfilling the request. For example, Processing System 162 may receive a request for a prepaid account card from a particular communication service provider of a particular dollar value with payment to be withdrawn from the user's debit account with a particular bank. Processing System 162 may evaluate the request and determine the various functional components to be executed, package the necessary data for each communication with another system, and coordinate the returned data to verify that the entire transaction is successfully completed. For example, Processing System 162 may send an inquiry to a processing server for prepaid account information for the particular communication service provider and value, may initiate a payment transaction between Payment System 170 and the communication service provider, may record the transaction in Transaction Data 163, and may await successful completion of each external transaction before reporting back to the requesting system (e.g., POS Terminal 110) that the transaction is complete. One embodiment of Transaction System 160 is further described below with reference to FIG. 3.

Processing Server 180 may include a database server for providing prepaid account number data in response to requests from Transaction System 160. Processing Server 180 may include or be connected to one or more data sources, such as Prepaid Account Data 181 and Approval Data 183. In one embodiment, Processing Server 180 may access data included in Approval Data 183 through Billing System 182. Prepaid Account Data 181 may include one or more database entries for one or more prepaid accounts. Each prepaid account database entry may include an access code, a prepaid account value, and a flag to determine whether the prepaid account is valid and in good standing. Approval Data 183 may include one or more database entries for one or more user prepaid accounts. Each user prepaid account may include user information, such as name, billing address, type of service, and other information, or may correspond only to a reusable prepaid account number or similar identifier not tied to the identity of the prepaid account user. Each prepaid account may include a value to determine the communication services available to the user through the prepaid account. This value may be adjusted by transactions initiated through Transaction System 160 in response to pre-payment of additional services. This value may be adjusted by Communication System 140 in response to communication services used through Billing System 182.

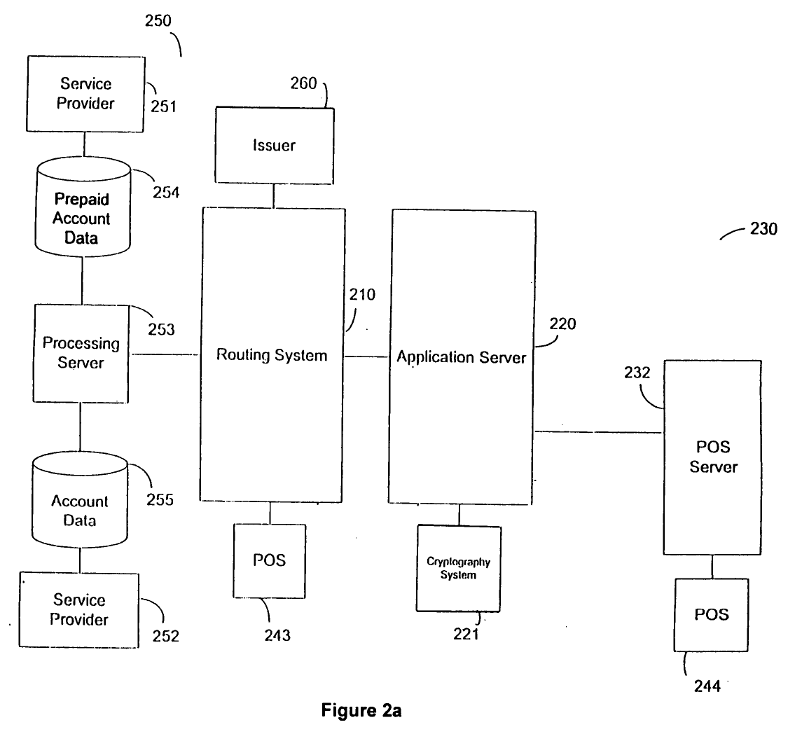

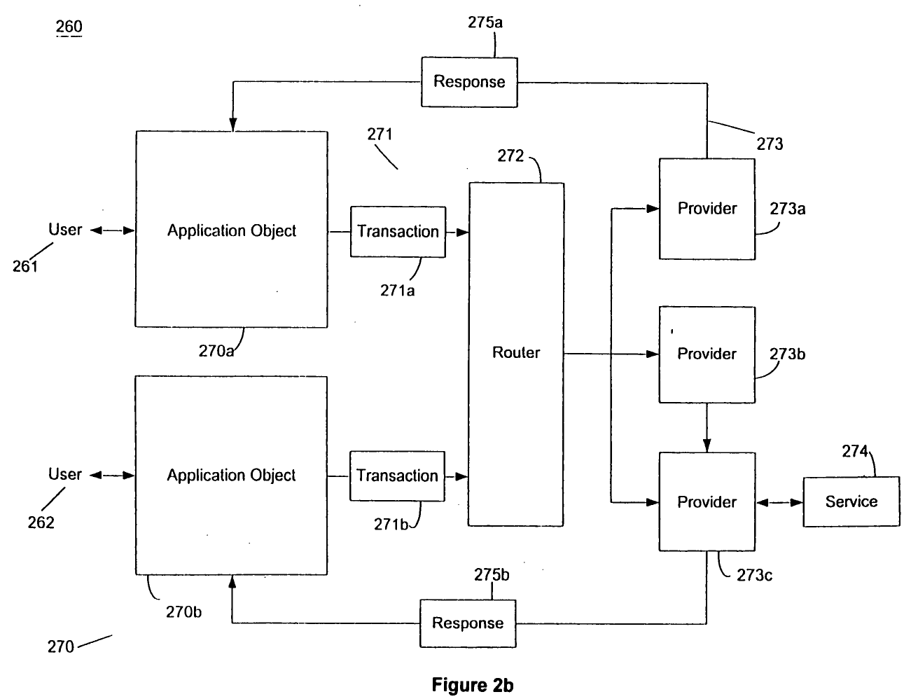

FIG. 2a shows a system for purchasing goods and services through a data network using one or more of a variety of terminal devices according to an embodiment of the invention. The system 200 includes a Routing System 210 and an Application Server 220 which act as intermediaries between one or more service provider systems, issuer systems, and terminal devices, such as POS terminals. Routing System 210 directs data transfer among data networks (e.g., EFT connection to an Issuer 260), service provider systems, the Application Server 220, and some terminal devices (e.g., POS system 243). Application Server 220 provides at least some logic, communication protocols, data storage, and/or transaction management for enabling various financial and banking related services utilizing financial data and other information directed through Routing System 210. In one embodiment, the system 200 may include a Cryptography System 221 to enable access to data networks requiring DES encrypted PIN blocks from terminal devices not equipped with DES encryption. Service Provider System 250 may be connected to Application Server 220 through Routing System 210. Service provider systems 250 may provide fulfillment and prepaid account maintenance for products or services purchased through system 200. Service Provider System 250 may include one or more service providers, such as Service Providers 251 and 252, one or more processing servers, such as Processing Server 253, and one or more data repositories, such as Prepaid Account Data source 254 and Prepaid Account Data source 255. Issuer 260 may provide electronic payment for products or services purchased through system 200.

In order to route communications, as referenced above, Routing System 210 includes switching and monitoring hardware and software for directing communications containing electronic financial data traffic to a predetermined destination according to the communications protocols appropriate to that organization. Routing System 210 further includes a hub for directing traffic in electronic financial data among a variety of otherwise incompatible communications networks and financial data systems. Routing System 210 may also include a number of communication channels and network connections for communicating the electronic financial data using EFT standards, Internet-based standards, proprietary standards, and other standards for secure data transfer. The communication channels of Routing System 210 may also serve to interconnect a variety of specialized and/or standalone financial end points, such as POS system 243.

In order to perform the above-described functions, Routing System 210 preferably includes an AS/400 platform using an OS/400 operating system and ITM 2.2 software for prepaid account access.

Application Server 220 includes one or more servers for hosting a plurality of financial and banking service applications, as well as service and product purchasing services. Such financial and banking service applications may include any service relating to personalized banking, finance, money management, payment transactions or investments. Application Server 220 further includes a platform for running the plurality of financing and banking applications. Application Server 220 utilizes a modular application design supporting standard interface objects to provide a flexible, readily expandable, and largely hardware-independent system for providing financial service applications. For example, Application Server 220 may be an enterprise application server running a plurality of applications composed of a plurality of interchangeable application modules (e.g., Enterprise JavaBeans). One application may enable Application Server 220 to initiate transactions (e.g., transfers and queries) with external financial network systems or service provider systems.

Application Server 220 may be connected to, and communicate with, Cryptography System 221 in order to enable the encryption of data in DES-encrypted PIN blocks compatible with POS network data encryption standards. For example, the Cryptography System 221 may be comprised of hardware for accepting a PIN from the Application Server 220, encrypting it using DES-encryption, and returning the DES-encrypted PIN block to the Application Server 220. The cryptography system may include a tamper-proof casing which disables the cryptography system if it is breached. Hardware encryption conversion prevents the decrypted PIN from ever being available in an electronic or visible form in which it could be misappropriated.

In one embodiment, a user's card data may be associated with the user's identification in such a way as to provide automated transactions utilizing the prepaid account card data. For example, a user's prepaid account data for his/her prepaid account card may be associated with a user's mobile telephone (e.g., by telephone number, subscriber number, or telephone identifier). An application may be defined that accepts a signal from the mobile telephone indicating the desire for a prepaid purchase transaction. The Application Server 220 may then execute a transaction for the purchase by identifying the mobile telephone, accessing the prepaid account card data, and routing appropriate transactions to the service provider providing the purchased goods or services and the issuer of the prepaid account card. In one embodiment, such a transaction may be initiated through a single entry from the mobile telephone, such as a one touch dialing function, a dedicated hardware button, a menu option, or another method.

Service Provider System 250 may include one or more computer systems maintained by or for one or more service providers, such as Service Providers 251 and 252. Service Providers 251 and 252 may include any business, financial institution, or other entity which maintains a system for dispensing products or services, such as a telecommunication company maintaining a communication network for vending communication services. Data repositories 254 and 255 may include any number of data repositories containing prepaid account data or information related to tracking prepaid account use. Data repositories 254 and 255 may be a localized data resource, such as a database or group of databases, or they may be a distributed resource, such as a batch of locatable files distributed across a network. Prepaid Account Data repository 254 may include approval response information, including prepaid account numbers, usage rights, usage tracking information, and other information for validating and monitoring prepaid account use. Account Data repository 255 may include account information including account numbers, usage rights, usage tracking information, user identification, and other information for validating and monitoring account use. Processing Server 253 provides an interface for communications, transactions, and data requests routed through Routing System 210 to data repositories 254 and 255. Processing Server 253 may include security verification, query protocols, and transaction maintenance for prepaid account data. Service Providers 251 and 252 may include similar protocols for interacting with the data stored in data repositories 254 and 255 in response to user redemption of products or services or other administrative functions. Alternatively, service provider communications may also be routed through Processing Server 253 or Routing System 210 (alternate configurations not shown). In another embodiment (also not shown), approval response Data repository 254 and/or Account Data repository 255 may be maintained directly by the Application Server 220 and service providers may direct communications, transactions, and queries through Routing System 210 to access the data. In still another embodiment (also not shown), a Prepaid Account Data repository 254 may be maintained within the Application Server 220 containing the prepaid account and values for approvals to customers. The Service Provider 251 maintains a separate Prepaid Account Data repository 254 containing approval response validation and use data. The Service Provider 251 provides batches of active approvals to Application Server 220 by download or other data transfer, but requires no further access to the delivered approval data. Application Server 220 maintains and sells the approval response batch without further need for communication with the Service Provider 251.

System 200 may include end points or terminal devices, such as POS system 232 and 244. The POS system may be a POS system integrated with a retail business, including its own application and interface software and capable of exchanging data with one or more financial networks through Routing System 210. The POS System may be a thin-client POS system which utilizes, at least in part, the application software of Application Server 220 and the interface software of POS Server 232. Other specialized thin-client terminal devices, such as Web and wireless Web devices are also possible in conjunction with a compatible interface server.

It will be appreciated that the POS terminal can be customized so that the user interface and/or the communications protocol are varied. For example, a dedicated user interface could have a dedicated prompt to enter the phone number rather than having to enter it in the PIN and amount fields.

In FIG. 2b, a modular system 260 for processing user product/service requests according to an embodiment of the invention shown. Modular System 260 may be used by an application server, such as the Application Server 220 in FIG. 2a, to process user product/service requests, such as requests for the purchase of goods and services. Modular System 260 includes a number of application objects 270, such as Application Objects 270a and 270b. Application Objects 270a and 270b are used as standard entry paths for user product/service requests, such as from Users 201 and 202. Application Objects 270a and 270b create a transaction 271, such as Transactions 271a and 271b, that describes the actions to be performed. Router 272 evaluates Transactions 271a and 271b and directs them to an appropriate provider 273, such as Providers 273a, 273b, and 273c. Providers 273a, 273b, and 273c include the operations for completing Transactions 271a and 271b. In some cases, a provider, such as Provider 273c, may issue a Service Request 274 to access an external resource, such as financial data maintained by a financial service provider. Providers 273a, 273b, and 273c may either direct the transaction to a further provider or may return a response 275, such as Responses 275a and 275b, to Application Objects 270a and 270b.

Application Objects 270 provide standard entry paths for user Product/Service Requests 261 and 262 and initiate transactions 271 within modular system 260. Application Objects 270 represent individual actions that Modular System 260 may be called on to perform. For example, Application Objects 270 might include a logon object, a prepaid account balance inquiry object, a prepaid purchase object, a balance inquiry, a prepaid account replenish object, and other objects for providing a variety of financial, administrative, bill paying, and other services. Each Application Object 270 creates a transaction 271 that describes the action to be performed and contains the user information necessary to initiate the action.

For example, an approval request inquiry transaction could be used to create a prepaid amount transaction including the value to be purchased and the method of payment for the purchase (possibly including a payment account number and PIN for security purposes). Each Application Object 270 may also call Router 272 in order to determine a destination Provider 273 to process Transaction 271. In one embodiment, Application Object 270 passes Transaction 271 to Router 272 where Router 272 evaluates Transaction 271 and passes it to a selected Provider 273. Alternatively, Router 272 may evaluate Transaction 271 but Application Object 270 actually passes Transaction 271 to the selected Provider 273 identified by Router 272. Each Application Object 270 may also receive a Response 275 from Providers 273 and pass the response back to the user. Each Application Object 270 may also be able to call a Provider 273 to undo, retry, or alter Transaction 271 in response to Response 275, new input from the user, or other system conditions.

Transactions 271, such as Transactions 271a and 271b, may include the data required by Providers 273 to fulfill the function of Application Object 270. Transactions 271 may include basic transaction information, such as a unique identifier, a time stamp, a status marker, and originator, and a destination (or list of Providers 273 for completing the transaction). Any amount of additional transaction-specific information may be added to a transaction as a data item.

In one embodiment, each Transaction 271 is stored as an XML document for access, evaluation, and modification by Router 272 and Providers 273. In another embodiment, each Transaction 271 contains a complete record of the history of the transaction. Each Transaction 271 may be automatically stored in a database and may be archived for later retrieval.

Router 272 determines a Provider 273 to handle Transaction 271. Router 272 uses a combination of transaction details and/or system information to determine the optimal destination Provider 273. For example, Router 272 may route the transaction data according to prepaid account number, transaction amount, or user name. Multiple routers may be employed by Modular System 260 to perform such routing. A single transaction may be routed several times over the course of its processing and Router 272 may be used by Providers 273 as well as Application Objects 270. Router 272 includes a routing table in the format of an extensible markup language (XML) document that lists the conditions and/or rules under which transactions 271 should be routed to a particular provider, such as Provider 273a, 273b or 273c.

Providers 273a, 273b and 273c utilize modules that include the logic for completing at least a portion of the functions performed by one or more Application Objects 270. Such Providers 273 use the data stored within Transactions 271 to perform such function. Providers 273 may return a response to the Application Object 270 which created Transaction 271 or may pass Transaction 271 to another Provider 273, with or without consulting Router 272. Providers 273 perform their function(s) locally using transaction data and local resources and system information and return a response 260 to the Application Object 270. Some Providers 273, such as Provider 273b, may also perform their function(s) locally using the transaction data and local resources and system information; however, their function(s) may be only a portion of the total function(s) required by the Application Object 270. The transaction 271 may be modified to include data generated by Provider 273b and may then be routed to another Provider 273, such as Provider 273c. Some Providers 273, such as Provider 273c, may route all or a portion of the data contained in the transaction 271 to a Service 274 and may then receive responsive data from the Service 274 to formulate a Response 275 to return to the Application Object 270. In one embodiment, a number of such Providers 273 may simultaneously work on the same Transaction 271. In another embodiment, the Providers 273 may pursue the same goal through different channels. For example, multiple Providers 273 may perform multiple services to get the most rapid response where response times vary (e.g., one external service provider may be faster than another external service provider for any given request depending on server availability and other factors).

A Service 274, such as a data courier service or a communication protocol service, may be used to exchange data with an external resource, such as a financial data network, bank, cryptography system, or data repository. Each Service 274 may be customized for the communications protocols and data requirements of a specific external resource. Service 274 may both send and receive data. The received data may be delivered to the Provider 273 which initiated the Service 274, added to the transaction and/or returned to the application object in a response.

Responses 275a and 275b may each contain an answer or resolution to the Transaction 271 created by the Application Object 270. Responses 275a and 275b may each include information requested by Application Object 270 or may include an explanation of why the request could not be fulfilled. In one embodiment, Responses 275a and 275b may each include a value to indicate whether or not the transaction was successful; a message that explains why the transaction was not successful; if necessary, a token, such as a reference to the present transaction, that can be used as part of a subsequent transaction; and a plurality of additional data items (as described above with respect to Transactions 271). The information returned in Responses 275a and 275b may be returned in whole or in part to the user who initiated use of Application Objects 270 and/or may be the basis of further transactions initiated through the same or another application object.

FIG. 3 illustrates a Transaction System 300 for providing a plurality of financial consumer and information services through a number of end points 310 using financial data, content, and transactional functions furnished by a variety of remote service providers, such as Fulfillment Service Provider 320 and Financial Service Provider 330. These services may be provided to a variety of service end points 310 from a number of interfaces supporting one or more interface standards and communication protocols. Exemplary service end points 310 include POS system 318. Integrated transaction management system 300 communicates with service end points 310 using any communication network such as the Internet, telephone networks, wireless networks, radio networks, and other communication networks and SMS, WAP, TCP/IP, and its corresponding data transfer protocols. The services performed by the Transaction System 300 may use information gathered from and/or exchanged with any one or more remote service providers. Transaction System 300 can communicate with the remote service providers by using any secure communication or data network.

Transaction System 300 may further include a variety of functional modules for providing financial and other information services according to an embodiment of the invention. The functional modules may each contain a combination of software and/or hardware for performing a task or set of tasks. For example, a data processor, memory, and an instruction set (i.e., computer code) may be all that are needed for such a functional module to carry out the tasks necessary for a given embodiment of each functional module. More commonly, however, multiple input and output devices, short term and long term memory systems, layers of computer code (i.e., operating system, application software, etc.), communication devices, and multiple processors may be used for such a functional module. Additionally, multiple ones of such functional modules may share the same hardware and portions of a software library. In some cases, a functional module may contain one or more other such functional modules. As will be understood by those of ordinary skill in the art, the functional modules described herein may be embodied in a large number of equivalent combinations of code objects and hardware. The combinations represented by the functional modules described herein are conceptual and should not be construed as a limiting structure for the multiple hardware and software combinations capable of executing the functional modules' tasks.

As shown in FIG. 3, Transaction System 300 includes an Interface System 340, an Application System 350, a Gateway System 360, and a Cryptography System 370. Interface System 340 includes one or more functional modules each of which provides one or more user interfaces accessible through a variety of service end points 310. Application System 350 includes one or more functional modules, each of which provides functional processing capabilities for one or more consumer applications, including formulating data queries and transaction requests for Fulfillment Service Provider 320 and Financial Service Provider 330. Gateway System 360 includes one or more functional modules for routing communications between a variety of disparate networks or communication systems using different communications, data transfer, and encryption protocols. Cryptography System 370 includes one or more functional modules for encrypting and decrypting data according to one or more secure encryption standards.

Interface System 340 includes one or more functional modules for presenting and exchanging information through thin-client end points or terminal devices Interface System 340 may access one or more of the functional modules providing consumer applications within Application System 350, and may provide an interface between such Application System 350 and a consumer as is appropriate to the varying bandwidths, memory capacities, processing abilities, input and navigation methods, and common uses and environments of the plurality of service endpoints 310 which may be utilized by the consumer. Even within a particular communications protocol, it may be preferable to offer multiple interface options depending on the attributes of a range of possible terminal devices and users. Interface System 340 may allow Transaction System 300 to support traditional POS-like functions through a variety of service end points 310 and enable the purchase of goods and services through transactions at those same service end points. As shown in FIG. 3, Interface System 330 includes a POS Interface module 345. Other interfaces may also be supported by alternate embodiments, such as interfaces supporting other wireless protocols and communications networks, voice interfaces for telephone access, proprietary and LAN interfaces for secure limited access special services (e.g., for service provider and system administrator side transactions and services), and additional interfaces to support the new and specialized capabilities of future networkable communication devices.

Application System 350 includes one or more modules for providing the functional processing for one or more consumer applications, including formulating data queries and transaction requests to facilitate the purchase of pre-paid goods and services. Application System 350 provides a variety of consumer applications according to a modular architecture that promotes interchangability, upgradability, and universality for access by a variety of interface modules serving a variety of service endpoints 310. Application System 350 utilizes data provided by a variety of external service providers, as well as internal system and data resources. A single application transaction may simultaneously or sequentially access data from, or initiate a data exchange with more than one service provider system. Application System 350 may formulate queries and issue data exchange requests based upon a variety of protocols dependent on the destination system and the information sought. Application System 350 may use a combination of Standard Query Language (SQL) and alternate data exchange and transaction protocols, depending on the compatibility of the service provider systems. In order to facilitate the purchase of pre-paid goods and services, one embodiment of the invention includes an Approval Module 351, a Prepaid Account Module 352, a Reporting Module 353, and a Payment Module 354. Each application module may include a variety of transaction modules for performing the variety of functions which may be included within the application module. The possibilities for additional application modules and alternative arrangements of application modules and component transaction modules are infinite.

Approval Module 351 provides maintenance and retrieval of approvals stored in one or more approval data sources. The approval data sources may be a localized resource or may be located remotely. Approval Module 351 provides transactions for retrieving available approvals from the approval database or creating new approvals to be added to the approval database. Approval Module 351 may also be able to return a non-approval in the event that the purchase transaction is not completed. Approval Module 351 may include a Get Approval module 351a and a Return Approval module 351b. In one embodiment, Get Approval module 351a is a provider object called by a purchase account application object in response to a user request to purchase a prepaid account card. Get Approval module 351a utilizes a query service to query the approval data source for an approval. The service response includes a flag designating the success or failure of the retrieval and data corresponding to the retrieved approval. In one embodiment, Return Approval module 351b is a provider object called by a purchase prepaid account card application object in response to an interruption in the transactions session, a rejected payment attempt, or other basis for aborting the purchase transaction. Return Approval module 351b utilizes a query service to notify the account number data source to return the included account number to an available status. The service response includes a flag designating the success or failure of the return attempt.

Prepaid Account Module 352 provides connectivity with existing user accounts stored in one or more prepaid account data sources. The prepaid account data sources may be stored locally or may be maintained remotely by a fulfillment service provider. Prepaid Account Module 352 may provide verification of the existence of a particular pre-paid account, verify that a pre-paid account is available for replenishing, retrieve the present value of a prepaid account, replenish the prepaid account, and provide other prepaid account maintenance functions. In one embodiment, Prepaid Account Module 352 may also allow a user to establish a new pre-paid account through Transaction System 300. Prepaid Account Module 352 may include a Verify Prepaid Account module 352a and a Replenish Prepaid Account module 352b. In one embodiment, Verify Prepaid Account module 352a is a provider object called by a replenishment account application object in response to a user request to replenish a pre-paid account. Verify Prepaid Account module 352a may use a query service to verify that a prepaid account number submitted by the user corresponds to an active prepaid account in the prepaid account data source. The service response may include a code indicating the success or failure of the verification, which may indicate an explanation of a failed verification attempt. In one embodiment, Replenish Account module 352b is a provide object called by a replenish account application in response to a successful payment transaction based on the user's submitted payment method (e.g., the clearance of an EFT transaction or credit card charge). Replenish Account module 352b utilizes a query service to notify the prepaid account data source to increase the value in the specified pre-paid account be a certain value. The service response includes a flag designating the success or failure of the replenish attempt.

Reporting Module 353 includes transaction monitoring and recording for administrative and billing purposes. Reporting Module 353 may include a reporting data source in which a record of each transaction, such as a prepaid account card purchase transaction or prepaid account card replenish transaction, is recorded. The transaction record may include transaction details, such as the time of the transaction, transaction value, transaction session time, service end from which the transaction was initiated, etc. The reporting data source may be used to provide transaction summaries to service providers for transaction verification and general account administration. The reporting data source may also be used to track the transactions for a particular service provider in order to assess payment for Transaction System 300's services on a usage basis. Reporting Module 353 may be used for other data mining activities, such as marketing analysis, and may be linked to user information to provide targeted marketing data.

Payment Module 354 provides for electronic payment of the value of the product or service to be purchased. Payment Module 354 may allow the user to pay for products and services using debit cards, credit cards, electronic currency, and any other electronic payment method as is known in the art. In a preferred embodiment, payment is handled through POS protocols for credit card and debit card transactions utilizing a magnetic card containing account information and a user supplied PIN. In an alternate embodiment, payment is provided through a service end device not equipped with a magnetic card reader and utilizing a registry of Track II data pre-registered by the user.

Routing System 360 may include one or more modules for directing communications between two or more of a variety of disparate networks or communication systems by using different communication, data transfer, and encryption protocols. For example, Routing System 360 may include an EFT protocol module, an Internet protocol module, a proprietary connection protocol module, or a variety of other communication protocols. In operation, Routing System 360 may receive transactions from a financial institution, another EFT gateway, a POS terminal, or Application System 350 (e.g., a purchase transaction through an alternate service endpoint). Upon receipt of the transaction, Routing System 360 determines the issuer using a Bank Identification Number (BIN) included in the data received, such as Track II data from a user's debit card. If the BIN belongs to a local bank, the transaction will be routed to the local bank for authorization. If the BIN does not belong to a local bank, then a routing decision will be made depending on the BIN number of the card. This routing decision will be determined by comparing the BIN to routing tables maintained within Routing System 360. When the BIN or some appropriate digits of the bin are found, the transaction is routed to the appropriate other gateway or financial institution for authorization. If the BIN is not found in the routing tables then a default gateway will be used to authorize the transactions. In one embodiment, a message from the application server may be received in a proprietary format and converted to a format appropriate for the issuing endpoint after the routing decision is made. An authorization will be received from the authorizing issuer and the transaction will be approved or declined based on the issuer's response. The Routing System 360 may also perform balancing and settlement with the authorizing issuer, as well as with the acquiring service provider.

As further illustrated in FIG. 3, Cryptography System 370 may include one or more modules for encrypting and decrypting data according to one or more secure encryption standards. Cryptography System 370 further includes cryptography hardware and software substantially as described above for Cryptography System 221 in FIG. 2a.

Fulfillment Service Provider Module 320 may be any system for providing goods or services and accepting payment from user's of those goods or services through Transaction System 300. Fulfillment service providers may include communication service providers, internet service providers, retail goods and service providers, vending machine operators, or other providers of goods and services. Each Fulfillment Service Provider Module 320 may include a system for product distribution, billing, and administration. In one embodiment, each fulfillment service provider maintains one or more computer systems for overseeing product distribution, billing, and administration and Transaction System 300 communicates with at least a portion of the computer system. Fulfillment Service Provider Module 320 may provide prepaid account data for use by the transaction system in retrieving and replenishing prepaid accounts. Fulfillment Service Provider Module 320 may also include a system for receiving payments for goods or services from Transaction System 300, a financial institution (e.g., though Financial Service Provider Module 330), or other sources. Fulfillment Service Provider Module 320 may include a Processing Application module 321, a Billing System 322, a Service System 323, and Prepaid Account Data Source 324, and an Approval Data Source 325.

Processing Application Module 321 may provide an interface between Prepaid Account Data Source 324 and/or Approval Data Source 325 and various systems which utilize that data, such as Transaction System 300, Billing System 322, Service System 323, and other systems (e.g., service provider administration, customer service, marketing, etc.). In one embodiment, Processing Application Module 321 may include protocols for integrating existing fulfillment service provider systems (e.g., existing account data, data management systems, billing systems, etc.) with Transaction System 300. Processing Application Module 321 may include an Approval Query Module 321a, an Approval Query Module 321b, a Prepaid Account Maintenance module 321c, and a Prepaid Account Maintenance module 321d. Approval Query Module 321a may allow Processing Application module 321 to receive and execute an approval data query (e.g., an account verification query, replenish account query, etc.) from Transaction System 300. Approval Query Module 321b may allow Processing Application Module 321 to receive and execute an approval data query (e.g., a get approval query, a return approval query, etc.) from Transaction System 300. Prepaid Account Maintenance module 321c and Prepaid Account Maintenance module 321d may allow Processing Application module 321 to receive and execute one or more maintenance actions for prepaid account transactions. Maintenance actions may include additional queries, data mining, data manipulation, and other actions to oversee Prepaid Account Data Source 324 or Prepaid Account Data Source 324. Maintenance actions may also include remotely accessing data or transactional capabilities in other fulfillment service provider systems (e.g., Billing System 322).

Billing System 322 may include the fulfillment service provider's systems for monitoring payments received and services due for pre-paid accounts. Billing System 322 may also include the fulfillment service provider's systems for monitoring, presenting, and reconciling payments due for non-pre-paid accounts or for pre-paid accounts initially paid for using credit or electronic currency and requiring actual payment from a third party (e.g., a credit card company, bank, or other financial service provider). Billing System 322 may include a pre-existing billing system established to handle consumer transactions other than sale of goods and services through Transaction System 300.

Service System 323 may include the fulfillment service provider's system for providing goods and services purchased using pre-paid accounts. Service System 323 may include authorization for distribution or access to goods and services, usage tracking for goods and services provided, and service or access termination based upon the fulfillment of pre-paid account value. Service System 323 may include a communication system for providing communication services to the user. In one embodiment, Service System 323 is a mobile telephone network and mobile communication services are provided to the user in accordance with the value and conditions upon which the pre-paid account card was purchased. In one embodiment, Service System 323 evaluates prepaid account data in Prepaid Account Data Source 324 or Approval Data Source 325 corresponding to user supplied prepaid account identification prior to providing goods or services. In one embodiment, Service System 323 may monitor usage of prepaid account data in order to identify when the value remaining in a pre-paid account is running low. Service System 323 may provide a notification to the user through one or more service end points. For example, Service System 323 may initiate an automated messaging service (e.g., telephone message, SMS message, voice mail message, electronic mail message, etc.) which warns the user that the prepaid account is running low. In one embodiment, a service end device may include a hardware (e.g., LED) or software indicator (e.g., display icon) to warn the user when the prepaid account is low. In one embodiment, replenish warning messages and indicators may be provided through Application System 350.

Prepaid Account Data Source 324 and Approval Data Source 325 include one or more databases of prepaid account or approval data providing prepaid account identifications and corresponding values of pre-paid services or goods.

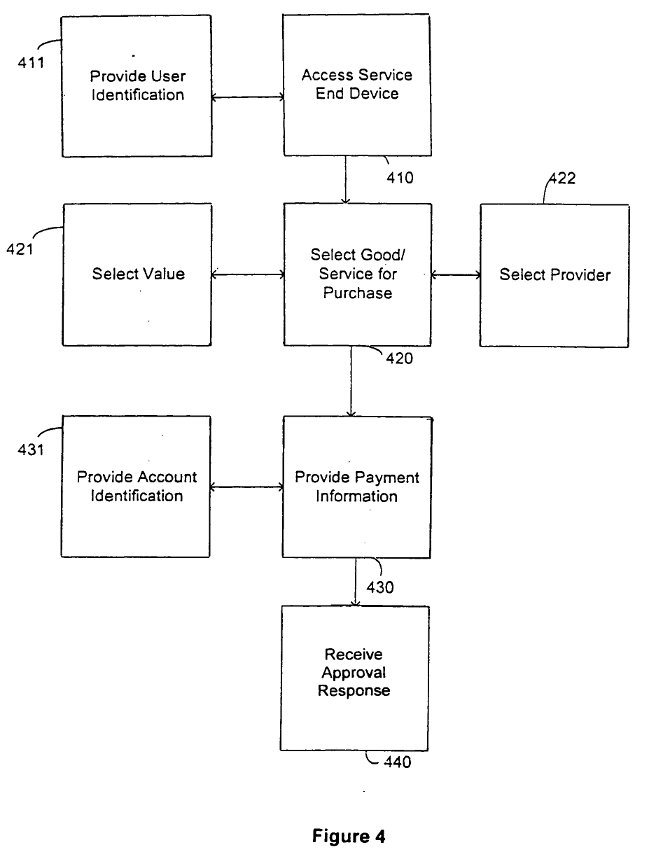

FIG. 4 shows a method of using a service end device, such as a POS terminal, to access a transaction system and a data network for the prepaid account card-based purchase of goods and services. In step 410, a user accesses a service end point, such as a POS system. For example, the user could approach a POS terminal and swipe a magnetic card to access the service functions of the system. Accessing a service end point may include providing user identification (step 411). For example, swiping a magnetic card may provide some user identification, such as a prepaid account number. The system may require additional identification for security purposes, such as a PIN, password, retinal scan, or other method to verify that the holder of the card is the authorized user. In step 420, the user may select a product, such as goods or services, for purchase. Selection may include multiple interactive steps. The user may first select a purchase option from a menu of system services (e.g., balance inquiry, purchase goods or services, etc.). The user may then select from a variety of products for purchase available through the system (e.g., mobile communication service, internet service, beverage, etc.). In one embodiment, a customized menu of purchase options may be offered based upon the identity of the user, location of the service end point, time of day, or other factors. Once a product for purchase is selected, a value for a product available in a variety of values (e.g., a number of mobile telephone minutes, a dollar amount of long distance service, etc.) may be selected (step 421). Selection of the value may be chosen from a menu of options or may allow custom entry of the value. A service provider from a list of available service providers may also be chosen (step 422). In step 430, the user provides payment information. Providing payment information may include providing account identification (Step 431). In step 440, the user receives an approval response. The approval response may be received as a printout through a service end point receipt printer. The approval response may also be dispensed solely as an access code displayed on the service end device display. The user then transacts using the prepaid account through a service provider, such as a communications company or vendor. In one embodiment, the user uses a communication device, such as a cellular telephone, to access a communication network and to use the pre-paid services.

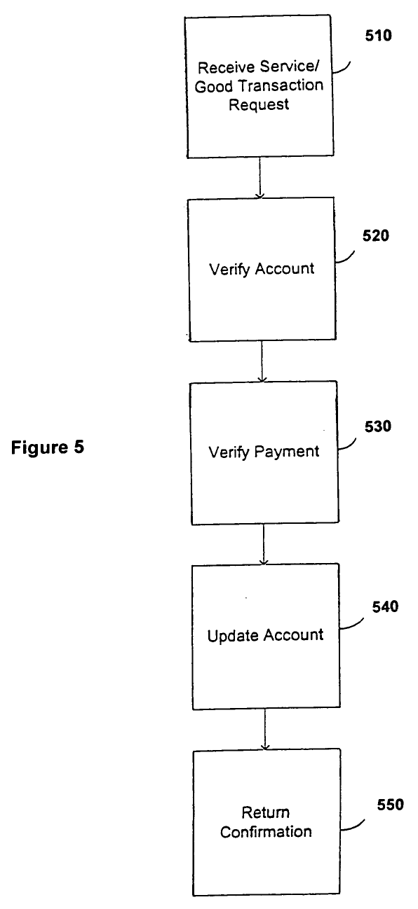

FIG. 5 illustrates steps in a method of replenishing a prepaid account with value redeemable for goods and services through a transaction system connected to a data network. In step 510, a transaction system receives a replenish transaction request. In step 520, the transaction system verifies the existence, authorization, and availability of the prepaid account for replenishing through the transaction system by querying a prepaid account data source. In step 530, the transaction system verifies user payment information through a data network from a financial service provider. In an alternate embodiment, the transaction system verifies that user payment has been received at remote locations (such as a retail outlet). For example, the user may appear at a retail outlet, tender payment in cash (or some other payment method accepted by the outlet), and the retail outlet may submit a user transaction request with an appropriate vendor code indicating that payment has been received. In step 540, the transaction system updates the user prepaid account according to the value purchased. In step 550, the transaction system returns confirmation to the user of the successful replenishment transaction.

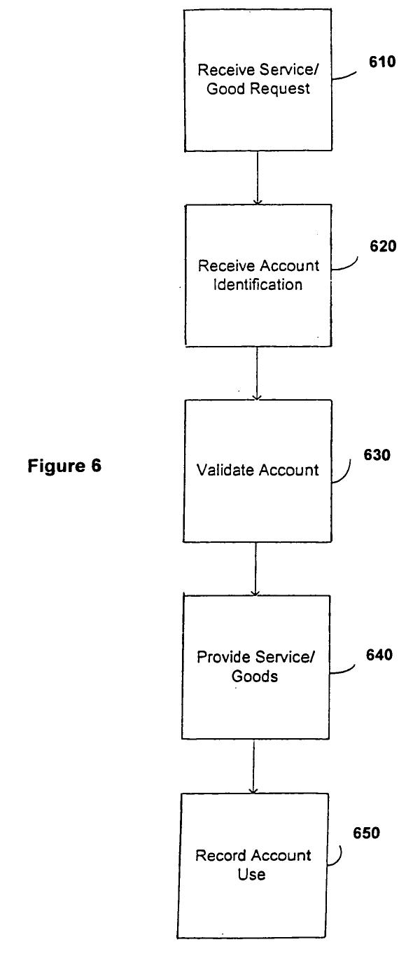

In FIG. 6, a method of providing goods and services based upon the value in a prepaid account replenished through a transaction system connected to a data network is shown. In step 610, a fulfillment service provider received a product request for goods or services according to a pre-defined product request protocol. In step 620, the fulfillment service provider receives a prepaid account identification corresponding to the user's replenished pre-pay account. In step 630, the fulfillment service provider validates the existence, authorization, and available value in the prepaid account by accessing a prepaid account data source. In step 640, goods or services are provided in accordance with the available value in the prepaid account. In step 650, the prepaid account record is updated to reflect the use of the prepaid account and any associated reduction in remaining value.

In one embodiment of the present invention, the process for initially registering the prepaid account card may have some additional features. For example, a subscriber wishing to credit his/her prepaid account using the present invention would provide the inactivated card to a merchant. First, the card is registered. The subscriber or merchant swipes the card through a standard POS device. Using a PIN-type transaction the subscriber or merchant enters the last four numbers of the subscriber's mobile phone number as the “PIN.” Then in the six-digit field, the subscriber or merchant enters the first six digits (i.e., the area code and the local exchange prefix) as the amount.

The entered PIN/amount data (i.e., the subscriber's mobile phone number), the account number and the BIN number are transmitted from the POS terminal to the POS processor for that merchant.

The POS processor and the POS network recognize the issuing party based on the BIN data and, accordingly, route the transaction data to the replenishment processor. The replenishment processor recognizes the transaction as a registration transaction because all 6 digits of the amount field are used. Accordingly, the replenishment processor updates a replenish database to include an entry for the new card. The entry includes the prepaid account number and the mobile phone number. If the card includes wireless carrier identification information, the entry may include such information. Alternatively, the replenishment processor can identify the wireless carrier corresponding to the mobile phone number using lookup services available in the industry. Identifying the wireless carrier can occur at the time of registration as a one-time procedure or, alternatively, could occur each time a replenishment transaction is performed.

The entry in the replenishment database may separately include the “PIN” that is subsequently used for replenishment transactions. In one embodiment, the “PIN” is the last 4 digits of the mobile phone number that is already stored, so that a separate entry can be avoided.

The registration process preferably includes a communication between the replenishment processor and the wireless carrier (or its billing agent) to confirm that the mobile phone number and the corresponding prepaid wireless account are valid and in good standing.

Once the registration process is complete, an OK or approval response is returned to the POS terminal to confirm that the card has been registered for that mobile phone account. The registration process need only be performed once.

Any time thereafter, actual replenishment transactions can be performed. The replenishment transaction is generally preceded by a conventional merchant-subscriber transaction, such as a cash transaction, a debit transaction, a credit transaction, among others.

By way of example, in a cash replenishment transaction, the subscriber provides the registered card to the merchant and requests a replenishment transaction for his/her prepaid account. Preferably, the replenishment transactions are in fixed denominations to simplify processing and to allow the replenishment processor to distinguish between registration transactions and replenishment transactions. For example, the system may permit replenishment transactions in amounts varying from $30 to $150 in $30 increments. By having a maximum value of $150 (which does not use all 6 digits of the 6 digit amount field in POS transactions), the replenishment processor recognizes that a submitted transaction using 6 digits of the amount field is a registration transaction, whereas a submitted transaction using 5 or fewer digits is a replenishment transaction.

Continuing with a cash-based transaction, the subscriber then pays the merchant $30 in cash and the conventional merchant-subscriber cash transaction is completed. The merchant or the subscriber then swipes the card and enters the PIN number (last 4 digits o the mobile phone number) in the PIN field and the amount ($30) in the amount field. The replenishment transaction information is transmitted to the POS processor and the POS network, where, based upon the BIN data, the transaction is forwarded to the replenishment processor as the “issuing bank.” The replenishment processor recognizes the transaction as a replenishment transaction. Using the PIN data (entered by the subscriber) and the prepaid account number (from the magnetic strip), the replenishment processor accesses the mobile phone number from the replenish database.

If the submitted replenishment transaction is not valid, a rejection is returned to the POS terminal. This may be the case if the submitted PIN does not match the prepaid account number or if the replenish account has been deactivated or otherwise is no longer valid.

Otherwise, the replenishment processor then prepares and submits a transaction to the wireless carrier (or its billing agent) to credit the subscriber's mobile phone account by $30. Preferably, this transaction is substantially real-time and involves a transfer of funds from the replenishment processor (“issuing bank”) to the wireless carrier (or its billing agent). If the prepaid wireless account is valid and in good standing, the prepaid account is credited and an OK or other approval is returned from the replenishment processor to the POS terminal via the POS processor and the POS network. If the prepaid wireless account is not valid or otherwise not in good standing, the prepaid account is not credited and a rejection is returned to the POS terminal.

Because settlement between the merchant and the replenishment processor (“issuing bank”) is time-delayed relative to the replenished transaction, the replenishment processor may also cross-reference the merchant ID with a merchant settlement account to confirm that the merchant is in good standing before executing the transaction between the replenishment processor and the wireless carrier.

As mentioned above, the replenishment transaction can also be preceded by a conventional non-cash merchant-subscriber transaction, such as a debit transaction or a credit transaction. In this implementation the merchant and the subscriber perform a debit or credit transaction, respectively, via the POS terminal. For example, the subscriber could execute a $30 transaction using his/her bank debit card or credit card. Once that initial financial transaction is complete, the prepaid account card is swiped, the PIN and amount ($30) is entered, and the remaining steps are as described above are performed.

It will be appreciated that the initial registration process need not occur only on a POS terminal. Other embodiments could occur via an IVR (Interactive Voice Response) system, Internet, or mail, among others.

This invention has been described in connection with the preferred embodiments. These embodiments are intended to be illustrative only. It will be readily appreciated by those skilled in the art that modifications may be made to these preferred embodiments without departing from the scope of the invention as defined herein.

What is claimed is:

1. A method for purchasing goods or services using pre-paid account cards, comprising the steps of:
(a) accessing a point of service device;
(b) selecting a good or service for purchase through the point of sale device;
(c) providing payment information through the point of sale device to a data network;
(d) receiving a prepaid account identification through the point of sale device from a mobile component; and
(e) replenishing the prepaid account by submitting the prepaid account identification to a provider of the selected good or service.

2. The system of claim 1, wherein the mobile component is a prepaid account card.

3. The system of claim 1, wherein the mobile component is a Universal Phone Card.

4. The system of claim 1, wherein the mobile component is a smart card.

5. The method of claim 1, wherein the step of providing payment information comprises tendering payment to a third party who provides a payment verification code for submission through the point of sale device.

6. A system for replenishing pre-paid services using a data network, comprising:
a mobile component including prepaid account data for a user's prepaid account;
a transaction system in communication with said prepaid account data for modifying said prepaid account in response to a user transaction request through a point of sale device;
a communication system in communication with said prepaid account for modifying said prepaid account in response to use of services associated with the user's pre-paid account; and,
a payment system in communication with said transaction system for executing a payment settlement transaction based upon fulfillment of the user transaction request.

7. The system of claim 6, further comprising a routing system for the data network and wherein the user service request is directed to the routing system by said point of sale device.

8. The system of claim 6, further comprising an application server and wherein the user service request is directed to the application server by said point of sale device.

9. The system of claim 6, further comprising a cryptography system and wherein at least a portion of the user service request is directed through said cryptography system and encrypted to meet encryption standards of the data network.

10. The system of claim 6, wherein the mobile component is a prepaid account card.

11. The system of claim 6, wherein the mobile component is a Universal Phone Card.

12. The system of claim 6, wherein the mobile component is a smart card.

13. A method of providing for initial charging and subsequent replenishment of a pre-paid account for goods or services through a data network, comprising the steps of:
(a) receiving a user transaction request for the initial charging or subsequent replenishment of a user's prepaid account through a point of service device;
(b) verifying the existence of the user's prepaid account through communication with an prepaid account data source accessible to the goods or services provider;
(c) verifying a payment method associated with the user's transaction request through the data network;
(d) updating the prepaid account to reflect the user's transaction request; and
(e) returning confirmation of fulfillment of the user's transaction request to the user.

14. The method of claim 13, further comprising the step of accessing a cryptography system for encrypting payment method data to provide to the data network.

15. The method of claim 13, wherein the step of verifying a payment method includes verifying payment received at a remote user location.

16. The method of claim 13, wherein the user transaction request comprises a single message including all user input for completing the initial charging or replenishment transaction.

17. A system for purchasing goods or services using pre-paid accounts comprising:
a prepaid account data source including a plurality of unique prepaid account identifiers;
a transaction system in communication with said prepaid account data source for retrieving a prepaid account identifier in response to a user transaction request; and,
a point of service device for accepting the user service request and accepting the prepaid account identifier from the user.

18. The system of claim 17, wherein the unique prepaid account identifier are contained on a mobile component.

19. The system of claim 18, wherein the mobile component is a prepaid account card.

20. The system of claim 18, wherein the mobile component is a Universal Phone Card.

21. The system of claim 18, wherein the mobile component is a smart card.

22. The system of claim 17, further comprising a data network in communication with said transaction system for providing payment settlement.
